(19) United States
(12) Patent Application Publication
(10) Pub. No.: US 2010/0033914 A1
(43) Pub. Date: Feb. 11, 2010

(54) KEYBOARD

(75) Inventors: AN-GANG LIANG, Shenzhen City (CN); ZHENG-HENG SUN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO.LTD., Shenzhen City (CN); HON HAI PRECISION INDUSTRY CO., LTD., Tu-Cheng (TW)

(21) Appl. No.: 12/237,242

(22) Filed: Sep. 24, 2008

(30) Foreign Application Priority Data
Aug. 11, 2008 (CN) 200810303648.0

(51) Int. Cl. G06F 1/16

(52) U.S. Cl. 361/679.08

(57) ABSTRACT

A keyboard includes a main body, a shield, and a pivot apparatus. The main body has a plurality of keys being arranged thereon. The shield is capable of covering the main body, and includes a cover board. The cover board has two first lateral plates and a second lateral plate. The two first lateral plates are extending from opposite ends of the cover board. The second lateral plate is extending from a front side of the cover board, and connected to a front end of each of the first lateral plates. The pivot apparatus is pivotably coupled between the shield and the main body.

### BACKGROUND

1. Field of the Invention

The present invention relates to a keyboard.

2. Description of the Related Art

Keyboards are standard equipments for using personal computers. Unfortunately, they are prone to getting dusty. Therefore, what is needed, is a keyboard which can solve the above problem.

### BRIEF DESCRIPTION OF THE DRAWINGS

FIG. 1 is an isometric view of an embodiment of a keyboard with a shield.

FIG. 2 is an isometric view of the keyboard of FIG. 1 with the shield closed.

FIG. 3 is an isometric view of the keyboard of FIG. 1 with the shield in a fully open position.

### DETAILED DESCRIPTION

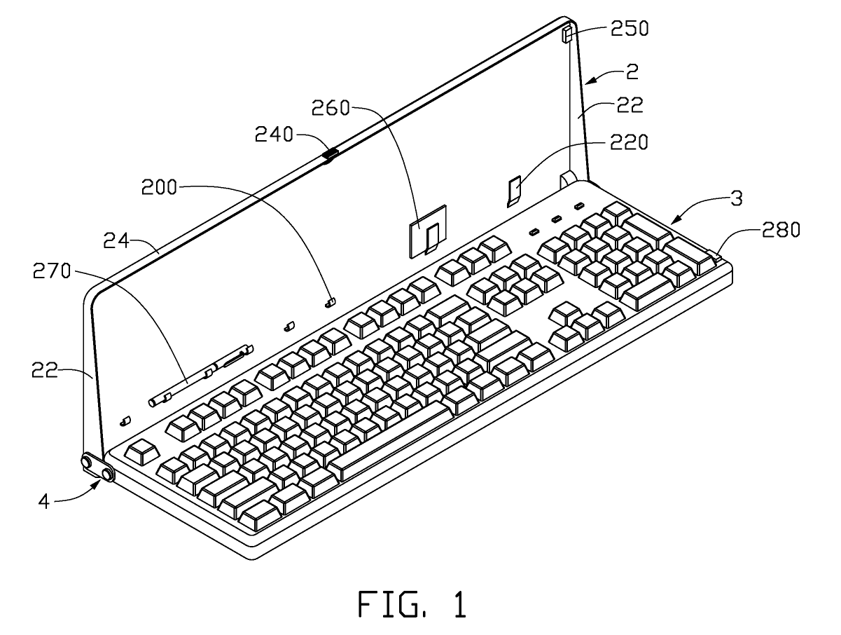

Referring to FIG. 1, a keyboard includes a main body 3 with a plurality of keys being arranged thereon, a shield 2, and a pivot apparatus 4 pivotably coupled between the shield 2 and the main body 3.

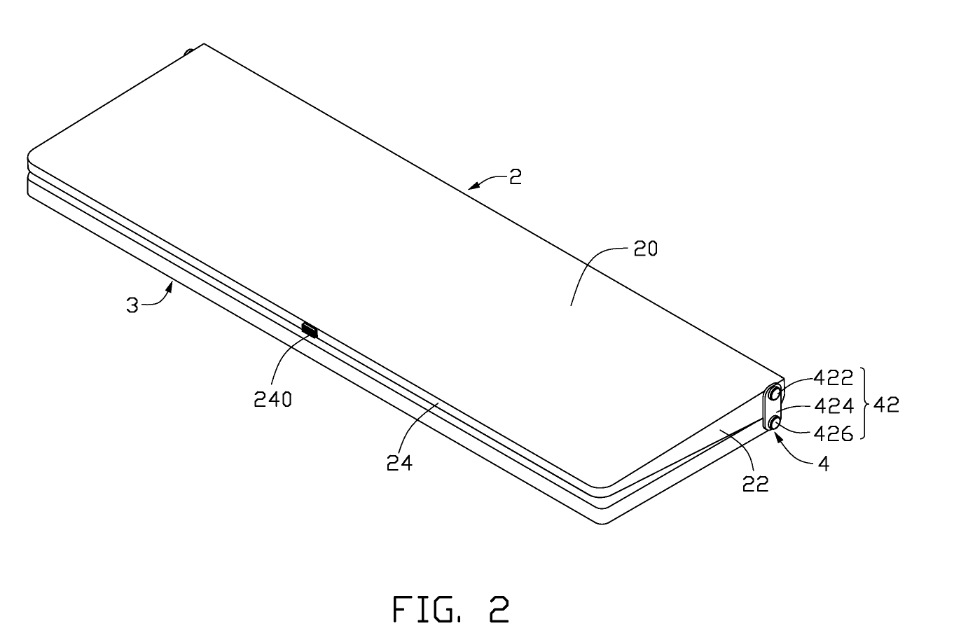

Referring also to FIG. 2, the shield 2 has a shape and size corresponding to the main body 3, and includes a cover board 20, two first lateral plates 22 perpendicularly extending from opposite ends of the cover board 20, and a second lateral plate 24 extending from a front side of the cover board 20. The second lateral plate 24 is connected to a front end of each lateral plate 22. A height of each first lateral plate 22 gradually decreases from a back side of the cover board 20 towards the front side of the cover board 20.

A plurality of hooks 200 and a plurality of clips 220 are arranged on an inner side of the cover board 20. Each hook 200 may be arc-shaped, and includes a first end extending from the inner side of the cover board 20, and a second end. Items such as a pen or a pencil 270 may be held in place by the hooks 200. Each clip 220 has a first end connected to the inner side of the cover board 20, and a second end elastically resisting against the inner side of the cover board 20. Flat objects such a business card or a memo paper 260 may be held in place between each clip 220 and the inner side of the cover board 20.

In one embodiment, an operation portion 240 is formed on an outer side of the second lateral plate 24 to conveniently open and close the shield 2. In one embodiment, a first magnet 250 may be positioned on the inside surface of the cover board 20. In the illustrated embodiment, the first magnet 250 is positioned at a corner of the cover board 20, neighboring the second lateral plate 24. Moreover, a second magnet 280 having an opposite polarity as the first magnet 250 is positioned on the main body 30 to come in magnetic communication with the first magnet 250 when the shield 2 is covering the main body 3. As a result, the cover board 20 and the main body 30 can be held together steadily by engagement of the first and second magnets 250 and 280.

The pivot apparatus 4 includes two rotating members 42 attached to opposite ends of the main body 3. Each rotating member 42 includes a first pin 422, a second pin 426, and a connection portion 424. Each connection portion 424 defines a first through hole in a first end therein and a second through hole in a second end therein. Each first pin 422 is passed through the first through hole and each second pin 426 is passed through the second through hole to engage with a rear end of the corresponding lateral plate 22. As a result, the connection portion 424 is capable of rotating around the first and second pins 422, 426, and the shield 2 is pivotably coupled to the main body 3.

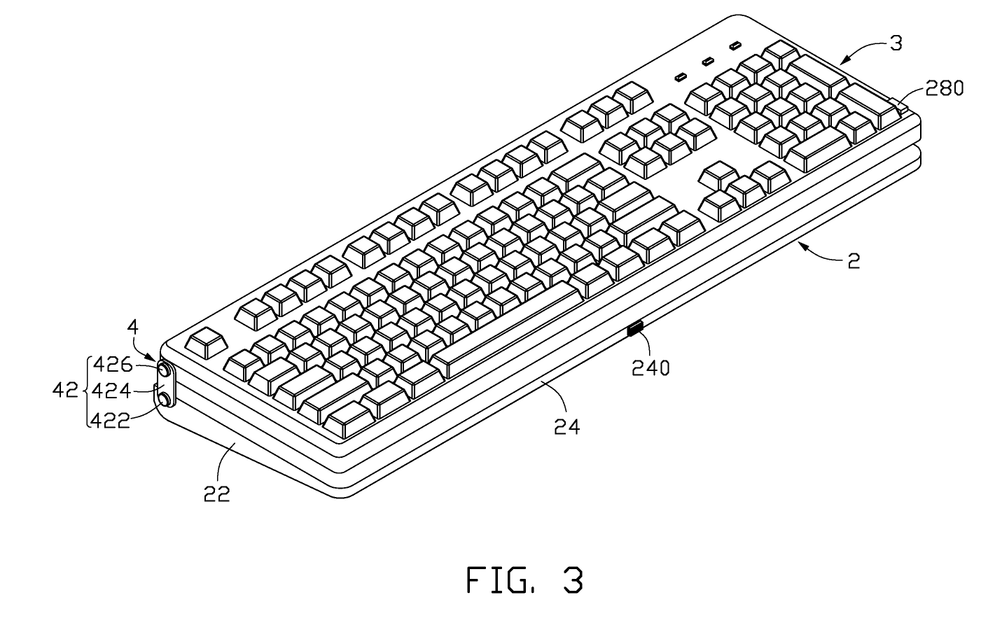

Referring also to FIG. 3, to protect the keyboard from dust when not in use, the shield 2 is rotated until it covers the main body 3. To use the keyboard, the shield 2 is pivoted open via operating the operation portion 240, and rotated to the back or underside of the main body 3. Because the height of each first lateral plate 22 decreases from the back side of the cover board 20 toward the front side of the cover board 20, the main body 3 is supported at an angle by the shield 2 to allow for comfortable use.

The foregoing description of the embodiments has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternate embodiments will become apparent to those skilled in the art to which the present invention pertains without departing from its spirit and scope. Accordingly, the scope of the present invention is defined by the appended claims rather than the foregoing description and the embodiments described therein.

What is claimed is:

1. A keyboard comprising:
a main body with a plurality of keys being arranged thereon;
a shield capable of covering the main body, the shield comprising a cover board having two first lateral plates extending from opposite ends of the cover board, and a second lateral plate extending from a front side of the cover board, the second lateral plate being connected to a front end of each of the first lateral plates; and
a pivot apparatus pivotably coupled between the shield and the main body.

2. The keyboard of claim 1, wherein a height of each first lateral plate gradually decreases from a back side of the cover board towards a front side of the cover board; the shield has a shape and size corresponding to the main body.

3. The keyboard of claim 1, wherein the pivot apparatus comprises two rotating members, each rotating member comprises a first pin, a second pin, and a connection portion; each connection portion defines a first through hole in a first end therein and a second through hole in a second end therein; each first pin is passed through the first through hole to engage with a rear end of a corresponding first lateral plate, each second pin is passed through the second through hole to engage with a rear end of the corresponding lateral plate, the connection portion is capable of rotating around the first and second pins.

4. The keyboard of claim 1, wherein an operation portion is formed on an outer side of the second lateral plate.

5. The keyboard of claim 1, further comprising a plurality of first magnets and a plurality of second magnets, wherein the plurality of first magnets are positioned on the cover board adjacent to the second lateral plate, and the plurality of second magnets are positioned on the main body to engage with the first magnets when the shield is covering the main body.

6. The keyboard of claim 1, wherein the cover board further comprises a plurality of hooks arranged on an inner side of the cover board, each hook is configured for supporting a pen or a pencil.

7. The keyboard of claim 6, wherein each hook is arc-shaped and comprises a first end perpendicularly connected to the inner side of the cover board.

8. The keyboard of claim 1, wherein the cover board further comprises a plurality of clips arranged on an inner side of the cover board, each clip is configured to clip flat objects together with the inner side of the cover board.

9. The keyboard of claim 8, wherein each clip comprises a first end connected to the inner side of the cover board and a second end elastically resisting against the inner side of the cover board.
